(19) United States
(12) Patent Application Publication
(10) Pub. No.: US 2006/0123031 A1
(43) Pub. Date: Jun. 8, 2006

(54) Prefiltering method and apparatus for prefiltering data stream for pattern matching

(76) Inventors: Seung Won Shin, Daejeon-city (KR); Jin Tae Oh, Daejeon-city (KR); Ki Young Kim, Daejeon-city (KR); Jong Soo Jang, Daejeon-city (KR); Sung Won Sohn, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/244,188

(22) Filed: Oct. 5, 2005

(30) Foreign Application Priority Data
Dec. 7, 2004 (KR) 10-2004-0102508
May 31, 2005 (KR) 10-2005-0046162

(51) Int. Cl. G06F 17/00; G06F 7/00

(52) U.S. Cl. 707/101

(57) ABSTRACT

A prefiltering method and apparatus for prefiltering a data stream for pattern matching are provided. The prefiltering method includes: receiving a data stream; loading previously stored filtering policies; filtering the data stream according to the loaded filtering policies and generating additional filtering information regarding the filtered data stream; determining whether to transmit the data stream to a search engine apparatus that performs pattern matching based on the additional filtering information; and transmitting the data stream to the search engine apparatus if the data stream is determined as requiring transmission. Therefore, it is possible to provide a high-performance pattern matching system that can achieve a high precision of pattern matching.

### CROSS-REFERENCE TO RELATED PATENT APPLICATION

This application claims the benefit of Korean Patent Application No. 10-2004-0102508 and 10-2005-0046162, filed on Dec. 7, 2004 and May 31, 2005, respectively, in the Korean Intellectual Property Office, the disclosure of which is incorporated herein in its entirety by reference.

### BACKGROUND OF THE INVENTION

1. Field of the Invention

The present invention relates to a prefiltering method and apparatus for prefiltering a data stream for pattern matching, and more particularly, to a prefiltering method and apparatus for prefiltering a data stream which enhance the performance of a pattern matching algorithm in a high-performance network system that compares an entire data stream with a predetermined pattern and searches for a portion of the data stream that matches the predetermined pattern.

2. Description of the Related Art

Pattern matching methods of matching a data stream with a predetermined pattern are widely used in a variety of devices, such as a router for looking up Internet Protocol (IP) addresses, a switch, and a security device for analyzing network data content. In pattern matching methods, a longest common subsequence (LCS) which is widely used in dynamic programming algorithms such as a hash algorithm is used. When there is a need to enhance pattern matching performance by, for example, quickly comparing a data stream with a predetermined pattern, amounts of data stream portions to be compared with the predetermined pattern must be reduced by using various pattern matching algorithms or other pattern matching methods. However, the harder the pattern matching algorithms or methods try to enhance the speed of pattern matching, the lower their precision of pattern matching. Therefore, the pattern matching algorithms or methods may not be able to enhance the general performance of pattern matching.

Conventional pattern matching methods used in a pattern matching system that searches a data stream for a match for a predetermined pattern use a variety of algorithms, and one of the algorithms is a hash function. In a conventional pattern matching method using a hash function, perfect matching is performed by obtaining a hash value for each of a plurality of data streams using a hash function and then primarily comparing each of the hash values with a predetermined pattern.

In the conventional pattern matching method using a hash function, input data streams must not be allotted the same hash value in order to enhance the precision of the primary comparison of the hash values of the input data streams with the predetermined pattern. Therefore, a hash value is generated for an input data stream based on all of a plurality of data values of the input data stream, thereby reducing the probability of a plurality of input data streams being allotted the same hash value.

In addition, a pattern matching system in a high-performance network system that uses the conventional pattern matching method using a hash function may not be able to properly process a series of input data streams unless quickly comparing hash values of the input data streams with a predetermined pattern.

FIG. 1 is a schematic block diagram of a conventional pattern matching system used in a high-performance network system. Referring to FIG. 1, the conventional pattern matching system generates a hash value for only some of a plurality of input data streams that are N bytes long instead of generating a hash value for each of the input data streams. Thereafter, the conventional pattern matching system primarily compares the generated hash values with a predetermined pattern and then performs a perfect matching operation based on the primary comparison results.

In detail, when a data stream is input via a high-performance network, it is input to each of a first delayer 101, a second delayer 102, . . . , an N-th delayer 10N, thereby generating time shifts among the data streams output from the first through N-th delayers 101 through 10N. The data streams output from the first through N-th delayer 10N are input to first through N-th hash functions 121 through 12N, respectively, thereby generating a total of N hash values, i.e., first through N-th hash values.

The first through N-th hash values are input to first through N-th comparators 141 through 14N, respectively.

The first through N-th comparators 141 through 14N download comparison information required for pattern matching from first through N-th tables 161 through 16N, respectively. The comparison information may be a hash value stored in each of the first through N-th tables 161 through 16N in advance.

The first through N-th comparators 141 through 14N primarily compare the first through N-th hash values with the comparison information downloaded from the first through N-th tables 161 through 16N.

However, assuming that the input data stream is M bytes long only an N-byte portion of the input data stream is subjected to the primary comparison operation. Given that one byte can represent up to 256 different characters, the remaining (M-N) bytes of the input data stream may imply up to (M-N)*256 different characters even when represented by the same hash value. Therefore, the probability of a randomly input M-byte data stream being incorrectly represented by a hash value can be calculated using Equation (1):

$$Pr ( M , N ) = \frac{1}{( M - N ) \times 256} .$$

For example, assuming that M=5 and N=2, the probability of the randomly input M-byte data stream being incorrectly represented by a hash value is 0.13%. The greater the difference between M and N, the lower the probability of the randomly input M-byte data stream being incorrectly represented by a hash value. The probability of a data stream being incorrectly represented by a hash value may vary depending on the type of an input data stream. However, it is almost impossible to anticipate what type of data stream is to be input, and thus, Equation (1) is still meaningful when calculating the probability of a data stream being incorrectly represented by a hash value. However, the probability of a data stream being incorrectly represented by a hash value is generally very low, and thus, it may be difficult to achieve a high precision of pattern matching by using a hash function. Therefore, additional information other than a hash value of an input data stream is needed when primarily comparing the hash value with a predetermined pattern for pattern matching.

### SUMMARY OF THE INVENTION

The present invention provides a prefiltering method and apparatus for prefiltering a data stream in a pattern matching system that searches an input data stream for a match for a predetermined pattern through comparison. In the prefiltering method and apparatus, additional information required for pattern matching is generated by compressing and/or filtering the input data stream, and the generated additional information is provided to a search engine apparatus so that it can be used in pattern matching performed by the search engine apparatus.

According to an aspect of the present invention, there is provided a prefiltering apparatus for prefiltering a data stream for pattern matching. The prefiltering apparatus includes: a reception unit which receives a data stream; a filtering policy storage unit which stores predefined filtering policies for a data stream; a filtering unit which loads the filtering policies stored in the filtering policy storage unit therein, filters the data stream received by the reception unit according to the loaded filtering policies, and generates additional filtering information regarding the filtered data stream; and a transmission determination unit which receives the additional filtering information and the data stream received by the reception unit from the filtering unit and determines whether to transmit the received data stream to a search engine apparatus that performs pattern matching.

According to another aspect of the present invention, there is provided a prefiltering apparatus for prefiltering a data stream for pattern matching. The prefiltering apparatus includes: a reception unit which receives a data stream; a division unit which divides the data stream received by the reception unit into a header portion and a content portion; and a compression unit which generates a compressed data stream by inputting the header portion and the content portion to a predefined compression algorithm, generates additional compression information regarding the compressed data stream, and transmits the compressed data stream and the additional compression information to a search engine apparatus that performs pattern matching.

According to another aspect of the present invention, there is provided a prefiltering method of prefiltering a data stream for pattern matching. The prefiltering method includes: receiving a data stream; loading previously stored filtering policies; filtering the data stream according to the loaded filtering policies and generating additional filtering information regarding the filtered data stream; determining whether to transmit the data stream to a search engine apparatus that performs pattern matching based on the additional filtering information; and transmitting the data stream to the search engine apparatus if the data stream is determined as requiring transmission.

According to another aspect of the present invention, there is provided a prefiltering method for prefiltering a data stream for pattern matching. The prefiltering method includes: receiving a data stream; dividing the data stream into a header portion and a content portion; generating a compressed data stream by inputting the header portion and the content portion to a predefined compression algorithm; generating additional compression information regarding the compressed data stream; and transmitting the compressed data stream and the additional compression information to a search engine apparatus that performs pattern matching.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of a conventional pattern matching system;

FIG. 2 is a schematic block diagram of a pattern matching system including a prefiltering apparatus for prefiltering a data stream for pattern matching according to an exemplary embodiment of the present invention;

FIG. 3 is a block diagram of a prefiltering apparatus for prefiltering a data stream for pattern matching according to an exemplary embodiment of the present invention;

FIG. 4 is a detailed block diagram of a filtering unit of FIG. 3;

FIG. 5 is a detailed block diagram of a compression unit of FIG. 3;

FIG. 6 is a flowchart illustrating a prefiltering method of prefiltering a data stream for pattern matching according to an exemplary embodiment of the present invention; and

FIG. 7 is a flowchart illustrating a prefiltering method of prefiltering a data stream for pattern matching according to another exemplary embodiment of the present invention.

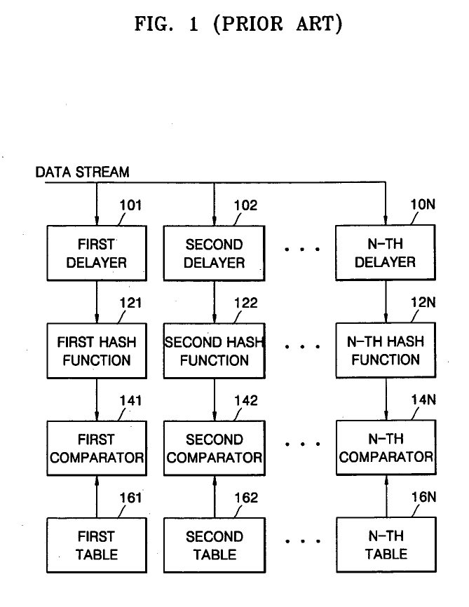

### DETAILED DESCRIPTION OF THE INVENTION

The present invention will now be described more fully with reference to the accompanying drawings in which exemplary embodiments of the invention are shown.

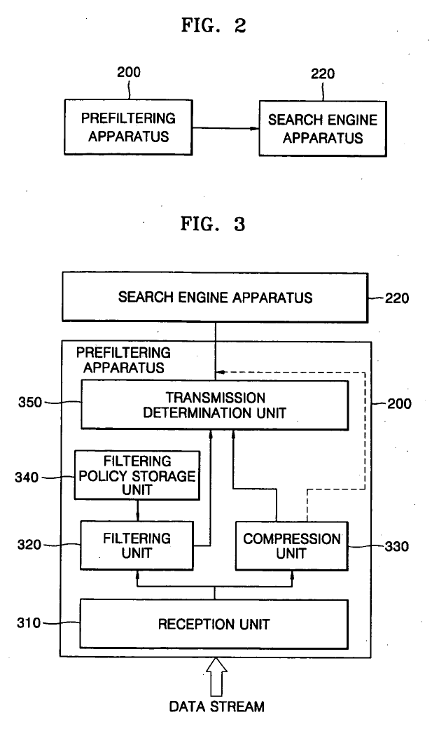

FIG. 2 is a schematic block diagram of a pattern matching system including a prefiltering apparatus 200 for prefiltering a data stream for pattern matching according to an exemplary embodiment of the present invention. Referring to FIG. 2, the pattern matching system includes the prefiltering apparatus 200 and a search engine apparatus 220. The prefiltering apparatus 200 receives a data stream via a network, compresses the data stream, and transmits the compressed data stream and additional compression information regarding the compressed data stream to the search engine apparatus 220. In addition, the prefiltering apparatus 200 receives a data stream via the network, filters the received data stream, and transmits additional filtering information regarding the filtered data stream to the search engine apparatus 220. The prefiltering apparatus 200 may perform a compression operation and a filtering operation in parallel on a data stream received via the network and may transmit the compressed data stream and additional compression information and additional filtering information regarding the compressed data stream to the search engine apparatus 220.

The search engine apparatus 220 performs a pattern matching operation based on determining factors provided by the prefiltering apparatus 200, including the compressed data stream, the additional compression information and the additional filtering information. Therefore, the pattern matching system can perform a pattern operation precisely and quickly using the determining factors provided by the prefiltering apparatus 200.

The operation and structure of the prefiltering apparatus 200 will now be described in further detail with reference to FIG. 3.

FIG. 3 is a block diagram of a prefiltering apparatus 200 for prefiltering a data stream for pattern matching according to an exemplary embodiment of the present invention. Referring to FIG. 3, the prefiltering apparatus 200 includes a reception unit 310, a filtering unit 320, a compression unit 330, a filtering policy storage unit 340, and a transmission determination unit 350.

The reception unit 310 receives a data stream via a network and transmits the data stream to the filtering unit 320 and the compression unit 330.

The filtering policy storage unit 340 stores predetermined filtering policies for a data stream. The filtering policies stored in the filtering policy storage unit 340 may have been received from an external system via the network or from a user via a user interface. The filtering policies stored in the filtering policy storage unit 340 may include a filtering policy for a header portion of a data stream and a filtering policy for a content portion of a data stream, both of which are stored in the filtering policy storage unit 340 separately from each other. For example, if the prefiltering apparatus 200 uses TCP/IP in an Ethernet environment, the filtering policy for a header portion of a data stream may be established to specify that transmission of only one of TCP and IP with which a pattern matching operation is desired to be performed is allowed by preparing an IP header or a TCP header for a MAC address. The filtering policy for a content portion of a data stream may be established to specify that a data stream whose content portion includes predetermined content should be prevented from being transmitted to the search engine apparatus 220 of FIG. 2.

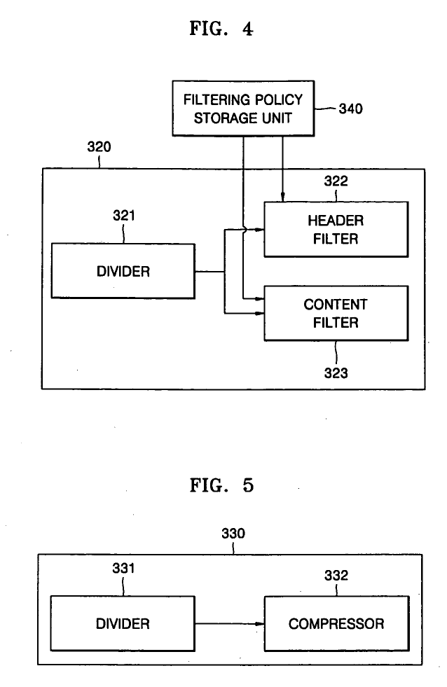

The filtering unit 320 loads the filtering policies stored in the filtering policy storage unit 340 therein, filters the data stream transmitted by the reception unit 310 according to the loaded filtering policies, and generates additional filtering information regarding the filtered data stream. Thereafter, the filtering unit 320 transmits the additional filtering information to the transmission determination unit 350. The operation and structure of the filtering unit 320 will be described below in further detail with reference to FIG. 4.

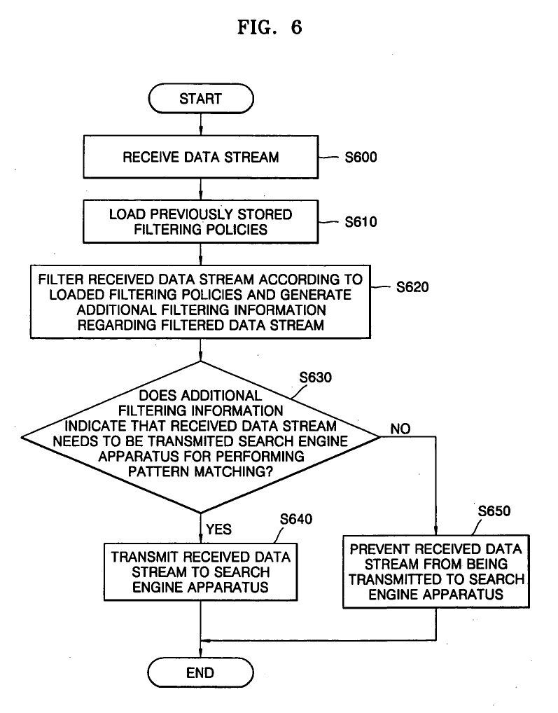

The compression unit 330 compresses the data stream transmitted by the reception unit 310 and transmits the compressed data stream and additional compression information regarding the compressed data stream to the transmission determination unit 350. The operation and structure of the compression unit 330 will be described below in further detail with reference to FIG. 5. Even though the compressed data stream and the additional compression information are illustrated in FIG. 3 as being transmitted from the compression unit 330 to the transmission determination unit 350, they may be directly transmitted to the search engine apparatus 220 as indicated by a dotted line in FIG. 3.

The transmission determination unit 350 receives the compressed data stream and the additional compression information transmitted by the compression unit 330 and determines whether to transmit the compressed data stream and the additional compression information to the search engine apparatus 220 by analyzing the additional filtering information transmitted by the filtering unit 320. If the transmission determination unit 350 decides to transmit the compressed data stream and the additional compression information to the search engine apparatus 220, it transmits the compressed data stream and the additional compression information to the search engine apparatus 220. The transmission determination unit 350 may also transmit the additional filtering information to the search engine apparatus 220 when transmitting the compressed data stream and the additional compression information to the search engine apparatus 220. When transmitting the compressed data stream and the additional compression information directly to the search engine apparatus 220 as described above, the prefiltering apparatus 200 may not include the filtering policy storage unit 340, the filtering unit 320, and the transmission determination unit 350.

Alternatively, the prefiltering apparatus 200 may not include the compression unit 330, in which case, the transmission determination unit 350 receives the data stream and the additional filtering information from the filtering unit 320 and determines whether to transmit the received data stream to the search engine apparatus 220 by analyzing the additional filtering information.

FIG. 4 is a detailed block diagram of the filtering unit 320 of FIG. 3. Referring to FIG. 4, the filtering unit 320 includes a divider 321, a header filter 322, and a content filter 323.

The divider 321 receives a data stream from the reception unit 310 and divides the data stream into a header portion and a content portion. Thereafter, the divider 321 transmits the header portion to the header filter 322 and transmits the content portion to the content filter 323. The header filter 322 loads therein a filtering policy for a header portion of a data stream stored in the filtering policy storage unit 340. Thereafter, the header filter 322 determines whether to filter the header portion received from the divider 321 according to whether the received header portion satisfies the filtering policy loaded therein. If the header portion transmitted by the divider 321 satisfies the filtering policy loaded in the header filter 322, the header filter 322 filters the header portion according to the filtering policy loaded therein, thereby generating additional header filtering information indicating whether the header portion has been filtered. The header filter 322 transmits the additional header filtering information to the transmission determination unit 350.

The content filter 323 loads therein a filtering policy for a content portion of a data stream stored in the filtering policy storage unit 340. Thereafter, the content filter 323 determines whether to filter the content portion received from the divider 321 according to whether the received content portion satisfies the filtering policy loaded therein. If the content portion transmitted by the divider 321 satisfies the filtering policy loaded in the content filter 323, the content filter 323 filters the content portion according to the filtering policy loaded therein, thereby generating additional content filtering information indicating that the content portion has been filtered. Thereafter, the content filter 323 transmits the additional content filtering information to the transmission determination unit 350.

FIG. 5 is a detailed block diagram of the compression unit 330 of FIG. 3. Referring to FIG. 5, the compression unit 330 includes a divider 331 and a compressor 332. The divider 331 receives a data stream from the reception unit 310 and divides the data stream into a header portion and a content portion. Thereafter, the divider 331 transmits the header portion and the content portion to the compressor 332.

The compressor 332 inputs the header portion and the content portion to a predefined compression algorithm, thereby generating a compressed data stream. Thereafter, the compressor 332 also generates additional compression information regarding the compressed data stream and transmits the compressed data stream and the additional compression information to the transmission determination unit 350, in which case, the prefiltering apparatus 200 includes the filtering unit 320. The predefined compression algorithm may output a data stream for each of the header portion and the content portion or may output a data stream for both of the header portion and the content portion. In short, by using the predefined compression algorithm, the compressor 332 may compress the header portion and the content portion together, thereby generating a compressed data stream for both of the header portion and the content portion, or may compress the header portion and the content portion separately from each other, thereby generating a compressed data stream for each of the header portion and the content portion. Examples of the predefined compression algorithm include the Message Digest 5 (MD5) algorithm and the Huffman algorithm.

If the prefiltering apparatus 200 does not include the filtering policy storage unit 340 and the filtering unit 320 but includes the compression unit 330, the compressor 332 transmits the compressed data stream and the additional compression information directly to the search engine apparatus 220. The additional compression information may include at least one of information regarding the predefined compression algorithm, the size of the compressed data stream, and header information of the compressed data stream.

FIG. 6 is a flowchart illustrating a prefiltering method of prefiltering a data stream for pattern matching according to an exemplary embodiment of the present invention. Referring to FIG. 6, in operation S600, a data stream is received via a network.

In operation S610, previously stored filtering policies are loaded.

In operation S620, the data stream is filtered according to the filtering policies, thereby generating additional filtering information.

In operation S630, it is determined whether to transmit the received data stream to the search engine apparatus 220 of FIG. 3 based on the additional filtering information generated in operation S620.

If it is determined to transmit the data stream to the search engine apparatus 220 in operation S630, the data stream is transmitted to the search engine apparatus 220 in operation S640. Otherwise, the prefiltering method proceeds to operation S650. In operation S650, the transmission of the received data stream to the search engine apparatus 220 is blocked.

In the prefiltering method illustrated in FIG. 6, a data stream received via a network is filtered according to previously stored filtering policies. However, it may be determined whether to transmit the data stream to the search engine apparatus 220 based on using a compression algorithm, additional compression information regarding the compressed data stream, and additional filtering information regarding a filtered data stream obtained by filtering the received data stream. In other words, if the compressed data stream does not satisfy the loaded filtering policies and thus is determined not to be output, the compressed data stream and the additional compression information are prevented from being transmitted to the search engine apparatus 220. The detailed description of the prefiltering apparatus as illustrated in FIGS. 2 through 5 is applied to the prefiltering method as illustrated in FIG. 6.

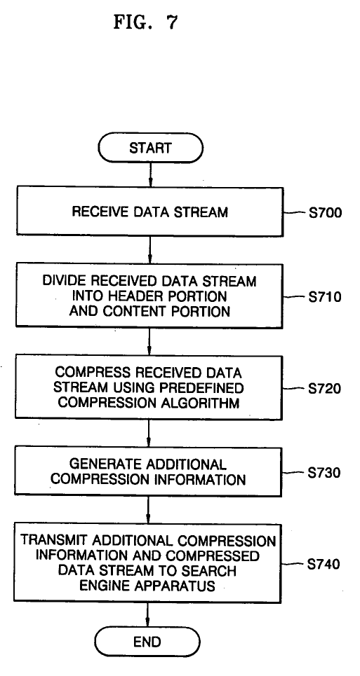

FIG. 7 is a flowchart illustrating a prefiltering method of prefiltering a data stream for pattern matching according to another exemplary embodiment of the present invention. Referring to FIG. 7, in operation S700, a data stream is received via a network.

In operation S710, the data stream is divided into a header portion and a content portion.

In operation S720, the header portion and the content portion are input to a predefined compression algorithm, thereby generating a compressed data stream.

In operation S730, additional compression information regarding the compressed data stream is generated.

In operation S740, the additional compression information is transmitted to the search engine apparatus 220 that performs pattern matching.

In the prefiltering method as illustrated in FIG. 7, a data stream received via a network is filtered according to previously stored filtering policies. However, it may be determined whether to transmit the data stream to the search engine apparatus 220 based on a compressed data stream obtained by compressing the data stream using a compression algorithm, additional compression information regarding the compressed data stream, and additional filtering information regarding a filtered data stream obtained by filtering the received data stream. In other words, if the compressed data stream does not satisfy the loaded filtering policies and thus is determined not to be output, the compressed data stream and the additional compression information are prevented from being transmitted to the search engine apparatus 220. The detailed description of the prefiltering apparatus as illustrated in FIGS. 2 through 5 is applied to the prefiltering method as illustrated in FIG. 7.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, code, and code segments needed for realizing the present invention can be easily deduced by one of ordinary skill in the art.

As described above, according to the preset invention, it is possible to prevent pattern matching rates from drastically decreasing in accordance with an increase of amounts of data streams processed by a high-performance network system and to equalize the amounts of data streams to be compared with a predetermined pattern. Therefore, it is possible to provide a high-performance pattern matching system.

In addition, it is possible to provide a high-performance pattern matching system that can achieve a high precision of pattern matching cooperating with other devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A prefiltering apparatus for prefiltering a data stream for pattern matching comprising:
a reception unit which receives a data stream;
a filtering unit which filters the data stream received by the reception unit according to predefined filtering policies, and generates additional filtering information regarding the filtered data stream; and
a transmission determination unit which receives the additional filtering information and the data stream received by the reception unit from the filtering unit and determines whether to transmit the received data stream to a search engine apparatus that performs pattern matching.

2. The prefiltering apparatus of claim 1, wherein the filtering unit comprises:
a divider which divides the data stream received by the reception unit into a header portion and a content portion;
a header filter which loads the filtering policies stored in the filtering policy storage unit therein, receives the header portion from the divider, filters the received header portion according to the loaded filtering policies, and generates additional header filtering information regarding the filtered header portion; and
a content filter which loads the filtering policies, receives the content portion from the divider, filters the received content portion according to the loaded filtering policies, and generates additional content filtering information regarding the filtered content portion.

3. The prefiltering apparatus of claim 2, wherein the header filter loads a predefined filtering policy for the header portion of the data stream received by the reception unit therein, and the content filter loads a predefined filtering policy for the content portion of the data stream received by the reception unit therein.

4. The prefiltering apparatus defined by claim 3 further comprising:
a filtering policy storage unit which stores said predefined filtering policies;
wherein said filtering unit loads the filtering policies stored in the filtering policy storage unit; and
wherein the filtering policy storage unit stores a filtering policy for the header portion of the data stream received by the reception unit and a filtering policy for the content portion of the data stream received by the reception unit.

5. The prefiltering apparatus of claim 1, wherein the additional filtering information comprises information specifying whether any of a plurality of portions of the data stream received by the reception unit matches the predefined filtering policies.

6. The prefiltering apparatus of claim 1 further comprising a compression unit which receives the data stream received by the reception unit, compresses the received data stream, generates additional compression information regarding the compressed data stream, and transmits the compressed data stream and the additional compression information to the transmission determination unit,
wherein the transmission determination unit receives the additional filtering information from the filtering unit and determines whether to transmit the compressed data stream and the additional compression information to a search engine apparatus that performs pattern matching based on the received additional filtering information.

7. The prefiltering apparatus of claim 6, wherein the compression unit comprises:
a divider which divides the data stream received by the reception unit into a header portion and a content portion; and
a compressor which generates a compressed data stream by inputting the header portion and the content portion to a predefined compression algorithm, generates additional compression information regarding the compressed data stream, and transmits the compressed data stream and the additional compression information to the transmission determination unit.

8. The prefiltering apparatus of claim 7, wherein the additional compression information comprises at least one of information regarding the predefined compression algorithm, information regarding the size of the compressed data stream, and the header portion of the compressed data stream.

9. The prefiltering apparatus of claim 6, wherein the transmission determination unit receives the additional filtering information from the filtering unit, determines whether to transmit the compressed data stream and the additional compression information to a search engine apparatus that performs pattern matching based on the received additional filtering information, and transmits the compressed data stream and the additional compression information to the search engine apparatus together with the additional filtering information when deciding to transmit the compressed data stream and the additional compression information to the search engine apparatus.

10. The prefiltering apparatus of claim 1, wherein, if the transmission determination unit decides to transmit the data stream received by the reception unit to a search engine that performs pattern matching based on the additional filtering information, it transmits the data stream received by the reception unit to the search engine apparatus together with the additional filtering information.

11. The prefiltering apparatus defined by claim 1 further comprising:
a filtering policy storage unit which stores said predefined filtering policies; and
wherein said filtering unit loads the filtering policies stored in the filtering policy storage unit.

12. A prefiltering apparatus for prefiltering a data stream for pattern matching comprising:
a reception unit which receives a data stream;
a division unit which divides the data stream received by the reception unit into a header portion and a content portion; and
a compression unit which generates a compressed data stream by inputting the header portion and the content portion to a predefined compression algorithm, generates additional compression information regarding the compressed data stream, and transmits the compressed data stream and the additional compression information to a search engine apparatus that performs pattern matching.

13. The prefiltering apparatus of claim 12, wherein the additional compression information comprises at least one of information regarding the predefined compression algorithm, information regarding the size of the compressed data stream, and the header portion of the compressed data stream.

14. The prefiltering apparatus of claim 12, wherein the predefined compression algorithm outputs a compressed data stream for each of the header portion and the content portion of the data stream received by the reception unit.

15. The prefiltering apparatus of claim 12, wherein the predefined compression algorithm outputs a compressed data stream for both of the header portion and the content portion of the data stream received by the reception unit.

16. A prefiltering method of prefiltering a data stream for pattern matching comprising:
receiving a data stream;
filtering the data stream according to predefined filtering policies and generating additional filtering information regarding the filtered data stream;
determining whether to transmit the data stream to a search engine apparatus that performs pattern matching based on the additional filtering information; and
transmitting the data stream to the search engine apparatus if the data stream is determined as requiring transmission.

17. The prefiltering method of claim 16, wherein the transmitting comprises transmitting the data stream to the search engine apparatus together with the additional filtering information.

18. The prefiltering method of claim 16, wherein the filtering comprises:
dividing the data stream into a header portion and a content portion;
loading the previously stored filtering policies, receiving the header portion, filtering the header portion according to the loaded filtering policies, and generating additional header filtering information regarding the filtered header portion; and
loading the previously stored filtering policies, receiving the content portion, filtering the content portion according to the loaded filtering policies, and generating additional content filtering information regarding the filtered content portion.

19. The prefiltering method of claim 16, wherein the additional filtering information comprises information specifying whether any of a plurality of portions of the received data stream matches the loaded filtering policies.

20. The prefiltering method of claim 16, wherein the determining comprises determining to transmit the data stream to the search engine apparatus if the additional filtering information specifies that none of the portions of the received data stream match the loaded filtering policies.

21. The method defined by claim 16 further comprising loading previously stored filtering policies, said previously stored filtering policies being said predefined filtering policies.

22. A prefiltering method for prefiltering a data stream for pattern matching comprising:
receiving a data stream;
dividing the data stream into a header portion and a content portion;
generating a compressed data stream by inputting the header portion and the content portion to a predefined compression algorithm;
generating additional compression information regarding the compressed data stream; and
transmitting the compressed data stream and the additional compression information to a search engine apparatus that performs pattern matching.

23. The prefiltering method of claim 22, wherein the additional compression information comprises at least one of information regarding the predefined compression algorithm, information regarding the size of the compressed data stream, and the header portion of the compressed data stream.
